(19) United States
(12) Patent Application Publication
(10) Pub. No.: US 2011/0261202 A1
(43) Pub. Date: Oct. 27, 2011

(54) Method and System for an Integrated Safe City Environment including E-City Support

(76) Inventor: Boris GOLDSTEIN, San Francisco, CA (US)

(21) Appl. No.: 13/090,514

(22) Filed: Apr. 20, 2011

Related U.S. Application Data
(60) Provisional application No. 61/326,857, filed on Apr. 22, 2010.

(51) Int. Cl. H04N 7/18; G08B 13/00; G06F 7/04

(52) U.S. Cl. 348/149; 348/143; 340/5.8; 340/541; 348/E07.085

(57) ABSTRACT

Described are use of clustered intelligent method of using video analytics, event driven systems and policy management for integrated approach to implement safe environment, such as a “Safe City” or “E-City,” supporting improvement in security and energy savings. The exemplary “Safe City” environment uses streaming video technologies, multi-function open source software, and high compression capabilities. Surveillance data of a predetermined geographical area may obtained using a computing arrangement, analyzing the surveillance data to detect at least one of a predetermined activity and a predetermined behavior of a entity within the predetermined geographical area, and adjusting at least one operation within the predetermined geographical area based on the at least one predetermined activity and predetermined behavior of the entity.

### PRIORITY CLAIM

The present application claims priority to U.S. Provisional Application Ser. No. 61/326,857 filed on Apr. 22, 2010 and entitled “Method and System for an Integrated Safe City Environment including E-City Support,” the entire disclosure of which is incorporated herein by reference.

### BACKGROUND

Videotaping has a huge impact on our lives. Cameras are used for memorializing important events, and to provide security for all kinds of businesses, from convenience stores to huge office complexes.

Facility Security in all shapes and forms has become one of the truly hot issues facing Governments, Institutions and Business around the World. While this is currently a high visibility issue worldwide, it represents an issue that has long plagued governments, facility managers and owners worldwide, and there is now a clear recognition that something needs to be done to strengthen the “Security Environment” of people in their business and leisure surroundings.

### SUMMARY OF THE INVENTION

The present invention relates to clustered intelligent method and system which use video analytics, event driven systems and policy management for integrated approach to implement Safe City including “E-City” support for security and energy savings.

Described herein are systems and methods which relate to use of clustered intelligent method of using video analytics, event driven systems and policy management for integrated approach to implement safe environment, such as a “Safe City” or “E-City,” supporting improvement in security and energy savings. The exemplary “Safe City” environment uses streaming video technologies, multi-function open source software, and high compression capabilities. In one exemplary embodiment of the present invention, surveillance data of a predetermined geographical area is obtained using a computing arrangement, analyzing the surveillance data to detect at least one of a predetermined activity and a predetermined behavior of a entity within the predetermined geographical area, and adjusting at least one operation within the predetermined geographical area based on the at least one predetermined activity and predetermined behavior of the entity.

### BRIEF DESCRIPTION OF THE DRAWINGS

FIG. 1 shows an exemplary system for defining complex scenarios (e.g., system events, system reactions) according to the exemplary embodiments of the present invention.

FIG. 2 shows an exemplary system of multiple video cups may be connected in a network via video switch according to the exemplary embodiments of the present invention.

FIG. 3 shows an exemplary system for centralized monitoring and managing numerous primary video systems according to the exemplary embodiments of the present invention.

FIG. 4 shows an exemplary system for operating system processes related to viewing video/audio, monitoring event and alert messages, retrieving archives, etc.

FIG. 5 shows an exemplary system for integration of distributed video surveillance and monitoring systems according to the exemplary embodiments of the present invention.

FIG. 6 shows an exemplary system for coordinating a video intelligent apparatus with numerous remote stations systems according to the exemplary embodiments of the present invention.

FIG. 7 shows an exemplary system including multiple video intelligent apparatus hubs under centralized supervision of several hub video intelligent apparatus according to the exemplary embodiments of the present invention.

FIG. 8 shows an exemplary system including multiple networked mobile apparatus according to the exemplary embodiments of the present invention.

FIG. 9 shows an exemplary system including a stand-alone video intelligent apparatus hub with numerous remote stations over different kind of media according to the exemplary embodiments of the present invention.

FIG. 10 shows an exemplary system for using a video intelligent apparatus hub as the basis component for multicast video over the Internet according to the exemplary embodiments of the present invention.

FIG. 11 shows an exemplary system including an exemplary system architecture for the POS intelligent apparatus according to the exemplary embodiments of the present invention.

FIG. 12 shows an exemplary system including an exemplary face capture function designed for detection and capturing of human faces according to the exemplary embodiments of the present invention.

FIG. 13 shows an exemplary system including a license plate recognition software module for license plate recognition according to the exemplary embodiments of the present invention.

FIG. 14 shows an exemplary system including video systems for defining customized architecture according to the exemplary embodiments of the present invention.

FIG. 15 shows an exemplary system including an exemplary intelligent video framework according to the exemplary embodiments of the present invention.

FIG. 16 shows an exemplary system for acquiring surveillance data with an intelligent monitoring arrangement according to the exemplary embodiments of the present invention.

FIG. 17 shows an exemplary system for an integrated, distributed, multi-layer intelligent video framework according to the exemplary embodiments of the present invention.

### DETAILED DESCRIPTION

Surveillance devices are common today and are used as a proven method for protection and risk management. Traditionally, the video security and surveillance market has been dominated by analogue cameras and recording devices (e.g., tape recording devices). These devices have technologically limited distribution means, as well as non-interactive display systems. With the advent of faster, less expensive computer systems, analog is giving way to “digital surveillance.”

According to one exemplary embodiment of the present invention, an exemplary “Safe City” may use streaming video technologies, multi-function open source software, and high compression capabilities to overcome traditional barriers truly creating a “force multiplier” (e.g., a single law enforcement officer or security guard having the ability to act as many individuals). Digital and analog surveillance cameras may be monitored using local and wide area networks, such as the Internet, in order to safeguard the populace and assets. Furthermore, these systems may be utilized in both government sectors as well as private sectors.

One of the advantages of the present invention is to provide, within a short time frame, an “enterprise class solution” to today's Security Environment and to take its position as the digital video surveillance standard, as the need and markets grow and mature. “Enterprise class digital security and surveillance systems solutions”, which records video images digitally, permits their viewing remotely, and allows “plug & play” option additions such as body tracking, facial capture and license plate recognition. The present invention may employ digital video data compression, which conserves space and time for transmission and storage.

Another one of the advantages of the present invention is to provide customized and integrated digital video system solutions for Government entities and companies in the security business, including security system manufacturers, integrators, telecommunications companies, and large computer manufacturers that offer total “enterprise class solutions” for their organization, region, and/or customers.

Yet another one of the advantages of the present invention is to include video management functions, video acquisition tools, specific applications functions, data control functions, and data communication functions. For management, a central station may monitor data and manages the infrastructure of large-scale system in the intelligent video framework. For video acquisition, an exemplary video intelligent apparatus allow for integrated video acquisition, monitoring, control, system management and data distribution in Intelligent Video Network. A hub video intelligent apparatus may provide video acquisition, monitoring, control and data delivering into multiple segments of the Intelligent Video Network. A video intelligent apparatus hub may provide remote video acquisition, camera control and data delivery within the intelligent video network.

For specific applications, face capturing may use integrated video and data acquisition, monitoring and data distribution system adjusted for human facial capturing. A body tracker may use integrated video and data acquisition, monitoring and data distribution system adjusted for human body tracking. License plate recognition (“LPR”) may use integrated video and data acquisition, monitoring and data distribution system adjusted for license plate pattern detection, capturing and recognition. Accordingly, this provides data collection, live querying and analysis. An automatic teller machine (“ATM”) intelligent apparatus may use integrated video/data acquisition and distribution system for cash dispensers and ATM operations. A point of sale (“POS”) intelligent apparatus may use integrated video and data acquisition, video security, monitoring and data distribution system in POS Networks. A remote station administrator may allow for a remote station operator based system to remotely control and management of small and compact scale systems. The operator may use remote video, audio and data monitoring within intelligent video framework, as well as partial remote control of multiple system components.

For data control, an access control apparatus may use integrated digital access control system adjusted for access management, data collection, live querying and analysis. An archive server may use network-based intelligent video/audio storage and archive retrieval system.

For data communication, a video router may use a network integration video recording and monitoring solution data distribution between multiple segments of the intelligent video network having secure access to/from the Internet (e.g., a firewall), and supports video web-multicast. A video switch may use data-stream bridging within intelligent video network.

The present invention may be customized and tailored digital video system providing a solution that will more closely match the behavior of the people using the system. This is especially true for complex security system requirements in government agencies and in commercial and industrial applications; water supplies, nuclear power stations, boarder crossings, strategic gas-oil pipe lines and reserves office buildings, manufacturers, refineries, banks chemical plants, etc.

The proposed invention may also provide for a reduction of risks. Whether it is terrorist activity, the random act of violence, the drain of employee theft, or the growing demand for information protection, solutions lie in two areas: changing technology and the augmentation of manpower and security services. Information and Physical Security, particularly premises such as government facilities, national historic sites, hospitals, parks, garages and privately operated but open-to-public properties—are on the short list of concerns. Variations on access control and video surveillance augment basics such as hardware as the main lines of defense, whether the risk is inside or outside technology is the “preventive measure.”

Today and tomorrow, close-circuit television (“CCTV”) and access control systems are computer-centric. Increasingly open architecture and flexible interfaces will continue to provide easier integration. True connectivity and data sharing between access control and other security systems such as burglar alarm, intercoms, guard paging and audio intercept is fast becoming a reality. This may be the case regardless of the manufacturer of the systems. In addition, non-security systems are increasingly dovetailing, if not integrating with, security systems. For instance, time/attendance and asset tracking for inventory management are leading the trend.

The degree to which security and computers are merged and networked, and on what platform, is of paramount importance. In the balance hangs the need for 24-hour, 7-day-a-week, uninterruptible protection on the one side, and the efficiency of enterprise-wide networks and their cost-saving infrastructures on the other. As of importance is how readily and reliably security can tap into such existing corporate computing networks.

The present invention may offer “integrated security solution” that permits any city to incorporate an infrastructure of multitude city districts into a state-of-the-art complex security system that can be controlled from a single point.

Proposed departments that may utilize such a system may include, but are not limited to, police and fire departments, emergency medical and hospitals vehicles, municipal buildings, traffic control management, transport facilities: airports, train stations, & ports, high security areas: power stations, nuclear facility, strategic gas and oil storage, injection wells.

Thorough ongoing city wide monitoring via implementation of large distributed video surveillance and video security system especially for occurrences such as, terrorist event, theft on the street and indoor, occurrence of crimes (e.g., robbery, assault, etc.), car theft, non-authorized outdoor occurrence, street incident.

The exemplary embodiments may use the integration of existing video security and surveillance systems with digital technology that provides unified system environment over large areas for video monitoring and messaging, control and management. The basis sub-systems of the “Safe City” may include, for example, “Safe Government,” “Safe Street,” “Safe Zone/Square,” “Safe Public Parking,” “Safe Park and Recreation Area,” “Safe Private Business,” “Safe Home/Apartment Buildings and Yards,” “Safe Hotel, Garage and Outdoor Environment,” etc. Each above sub-system is based on multiple indoor/outdoor video cameras, sensors and the hierarchy of video acquisition units, which are proposed for digital data delivering to a neighborhood security center, a police department, a security guard or any other data center. A primary concern of video monitoring may include entrances, gates, check points, garbage collectors, and other places that have been marked with the “Safe City” sign. Video data will be periodically delivered in the database of local police department or security guard of neighborhood watch center. The depth of the video database is adjusted according to local requirements and may be in the range from one week up to several months. On the event of crime required video and other data may be delivered to the video central station of the “Safe City” then distributes information to federal and local police departments via mobile data terminal (“MDT”) or a portable station in the police car and other destination in order to simplify search and investigation processes.

Integrated system for human face detection and capturing supports centralized database of human facial images in the “Safe City”. The image database is updated constantly and keeps facial images in standard size/scale with corresponding information about time, date and place in the “Safe City”, where that face has been captured. For instance, an appropriate city department may inquiry information on demand, such as, by asking “where was that person in the city for last week?,” “how often did that person come in such entrance?,” etc. Accordingly, continuous image comparison with a criminal database may instantly notify and deliver required information about every finding in the city. Multiple distributed face capture systems may solve special problems in the Government, private business and public environment for the protection of human life and the warning of danger. Local tasks related to human body detection and instant messaging are directed for secured and Prohibitive areas of the “Safe City”, where human existence shall generate instant alert at local site and required control center via complex combination of notification media. One of the purposes for instant notification may be also a local notification before possible crime or event, or a notification that targeted to divert personnel and protect further motion in restricted area.

Complex task in the security and monitoring of public access areas. Proposed invention based on image pattern recognition or optical character recognition (e.g., a LPR system) may prevent any non-authorized attempt to enter or leave secured environment. The database keeps the numbers of recognized car license plates for required period and provides fast search and instant notification if a queried number is captured.

For instance, implementation of the LPR system at parking lot may simply alert and determine that a particular car is stolen based on the identified license plate. Further integration with the access control system and “weight & measurement” or “car body identification” systems enhances the level of defense, as well as improved environment filters for authorization and authenticity of the security pass sensitive. For example, the gate may only open if complex identification criteria is met (e.g., license plate, proximity card, car model, etc.), and then the vehicle is permitted and passed.

Transportable monitoring that ensures the capturing of license plates at multiple locations providing number recognition with instant database support. The LPR system provides the ability for tracking and search for a license plate that is requested by appropriate departments. The License Plate Recognition system is adjusted for video monitoring on highway and expressway, where the vehicles travel at high speed. A Unified database of recognized license plates, images or other data (e.g., speed, location, etc.), distributes the processes of analysis, query and notification to provide additional information for the defense and warning of a “City Environment” and notifies the appropriate departments. For example, the LPR system can notify local police department, when a specific car passed a checkpoint, entered or exited a highway.

The exemplary embodiments may also provide mobile apparatus system for video security, such as digital video recording (“DVR”) and vehicle tracking. The mobile apparatus system may be located in a vehicle for instant capturing of license plates, alarm images recording videos and sound according to the specific need and scenario (e.g., sound, manual action, vandalism attack, etc). Depending on a particular application, the mobile apparatus may collect data to be accessed at stationary or other mobile site via moveable mobile module and “mDock” docking PC station. Simple procedure in data maintenance and operation prevents data losses and missing important events. Further integration with global positioning system (“GPS”) tracking and short message service (“SMS”) messaging provides total tracking and monitoring of the mobile environment remotely. Accordingly, the multiple systems may solve many issues for transportation and cargo or applied to mobile facilities.

Indoor video security, alarm notification and centralized services for multiple subscribers of “Safe City” are proposed for home and office security distributed over city districts and departments. Multiple video embedded processors, video intelligent apparatus hubs, may be distributed over secured areas and deliver data to required departments in the “Safe City”. In addition, flexible arrangement for on-demand access may provide secure and instant notification of pre-defined situations with the feature for video and data analysis.

The spectrum of the tasks is not limited and may be updated by other departments of the “Safe City.” Total implementation of the video system in the “Safe City” will not allow crime to hide and provide evidentiary video after the event. It will also provide reliable evidentiary information in order to prevent crime, detect traffic incident and other pertinent information for required departments of the “Safe City.”

According to the exemplary embodiments of the present invention, method and system may be based on proprietary technology, such as a computerized “intelligent core” for custom-design of integrated, distributed, and automated “enterprise class solutions.” These embodiments may include a complete spectrum of data1 acquisition and processing, tracking, search, notification, and other features of rule-based, as well as open-ended and object-oriented architecture, to achieve a truly “intelligent security system.”

Exemplary intelligent video framework may be based on modern technologies and problem solving for multiple integrated and distributed applications. These applications may include, but are not limited to, video surveillance and digital video recording, OCTV/CCTV Security, I/O control and access control, fire-alarm and burglar-alarm, announcement and reporting, remote monitoring and remote control, total automation, etc. Therefore, each of the above fields may be integrated into an “enterprise class solution” to enhance coverage and performance of the exemplary systems and methods.

The exemplary embodiments may provide several significant attributes for “enterprise solutions,” such as, integration, distribution, complexity, efficiency, redundancy, mobility, authenticity, instant informing and intelligence & flexibility. Integration of numerous security components in unified system environment is based on object-oriented and event-driven architecture, which allows multiple accesses to different media units from any location like CCTV, ATM, POS, alarm receiver, burglar alarm, video archives, event databases and other equipment via custom-defined graphic user interfaces (“GUI”), etc. The distribution of multiple processes over secured areas may enhance fault-endurance, provides relative intelligence at each location and simplifies system control of complex environments. The complexity of an integrated solution is the option that helps you in the design of a wide range of applications from stand alone video server at home and remote station in the office up to enterprise solution with thousand.

The exemplary embodiments may include targeted and distributed system components within multiple video networks and Internet. For instance, system components may allow for a video system to be designed with numerous monitors and control centers that may be automated via custom control scenarios and adjusted to human need in order to achieve “force multiplication” of the security system. Stand-alone system solution at the minimum requirements, as well as every product, may be multiplied by any order within the video networks to achieve an efficient and redundant “enterprise class solution” for video, audio and event data analysis and storage. Multiple distributed engines and databases of the systems may define redundant system architecture in order to protect data losses and keep functionality when system parts malfunction or communication broken. Through the use of intelligent backup connectivity, fault-tolerant and self-recovered architectures may be provided within integrated video security and complex custom-defined applications.

The exemplary embodiments may provide multiple independent performed functionalities, such as, simultaneous and continuous motion detection, recording of many cameras, and playback video/audio from any archive. Furthermore, these exemplary systems and methods may provide flexible event-based triggering for video/audio recording, alerts and system reaction, as well as on-the-fly system adjustments, updates and integration with new installed equipment for continuous operations and system maintenance.

An intelligent video motion detection (“VMD”) of the exemplary embodiments may provide filtering of optical noises and adjusted for outdoor control. For instance, multiple motion masks with free-defined shapes may allow for ignoring motion and reducing false alarms. Delta-wavelet video compression may provide the greatest balance between frame size and video image quality. Five levels of video compression may allow adjustments of the capacity of video archive and the performance of remote video monitoring over low bandwidth communication line accordingly. Control scenarios based on multiple macros and scripts may allow for adjusting system behavior according to human factors. Custom-defined macros and scripts may provide complex relations between system components and its dependencies. Accordingly, a third party system may be completely adapted to real environment and system behavior will match to human factor.

High-performance multi-channel video processor provides multi-triplex operations, such as simultaneous, continuous and live VMD, compressed video recording, video displaying, video archive retrieval and search, etc. Real time video recording and synchronous event database supporting detailed protocol of alarm events. In addition, long-term video archive may be constructed using single or multiple video central stations. Instantaneous switching to alarm video channel allows for the recording many more frames over a traditional analog system.

This video intelligent apparatus, as well as other framework equipment, may utilized in a unified information environment with redundant and event-driven architecture. Furthermore, individual information access is provided by multiple and hieratic of User's Rights agreements.

Authenticity is based upon a customized relationship between required system components (e.g., camera, microphone, sensor, relay, speaker, card reader, ATM, etc.) via multiple custom-defined control scenarios, macros and scripts, etc. A user may customize function-dependencies between any system components and its groups in order to minimize the number of false alarms and enhance the rate of alarm authenticity. Real time video data filters ignore optical noise and video signal tolerances provide high quality for indoor and out door video. The use of DVR systems may provide stable video quality without frames lost after event. An exemplary pre-alarm record feature allows the acquisition of video data for a number of seconds before alarm event. The pre-alarm record time may be adjustable according to real environment and scenario requirement.

Digital image enhancement systems may enhance a video image in real time or after the fact in case of insufficient visibility. For instance, each camera of the system may follow individual definitions, and video loss detection may instantly sends out event information and freezes last still image. Synchronized video/audio and system events may be stored in a complete database of the system, wherein the information of the database may be distributed over large area. System engine may provide instant data retrieval on demand that is based either upon required event, date and time or control scenario. Multiple events based upon complex inquiry may define the fault-tolerant system reaction according to custom definition.

Instant notification of custom-defined events or actions is customized according to specific needs. Technology alert notification has a wide range of options and media using GUI, voice, sound, light, email, still image, report printing, pager, phone call, fax, data export, etc. Smart video search in the archive from any location and visual identification on demand, instant alarm localization and other system features will give you instantaneous access to time-sensitive information. Direct access to video data from history of events. Displaying video on the monitor when an alarm or video motion detected. Displaying alarm message in popup window; Automatic displaying of corresponding level of digital mapping where alarms have occurred, other custom rule-based features using dial-up cellular telephone, print image, send email, siren, lamp, buzzer, and other system notifications. The ability of pre-alarm video recording allows the acquisition of video before the real event occurred. Digital video playback and “smart search” of video archive allows searches based on date and time. Remote monitoring over network connection; satellite, wireless, intranet, Internet or dial-up, etc. Intuitive user interfaces, alarm messaging on the screen and voice notification provide custom defined ranges of necessary information for personnel to make the right decision fast. The exemplary embodiments may provide automatic problem solving regardless of the attention of the system operator, wherein the autonomous features may be based on beforehand designs and the logic of system behavior.

As noted above, the exemplary embodiments may use an intelligent video system featuring a proprietary core and intelligent video framework. These systems may include enough information and technology to support control-decisions of security service utilizing the selection of required information and filtering unnecessary information. These systems and methods may be designed for interactive operation with system operator, and provide accurate adjustments according to system requirement and human behavior. The present invention may define any number of actions and/or custom defined event filters, and may be configured to handle many parameters for each event. Any activities happening inside the system (e.g., motion detection alarm, fire alarm, illegal access, intrusion into secured areas, etc.) may be seen as an event.

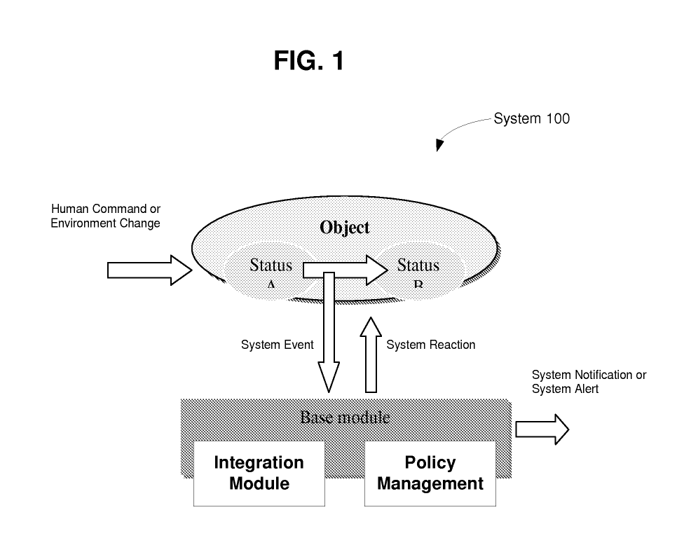

Action after event may be started automatically, such as, for example, the activation of a video recording system and/or the restriction of access to any room. Accordingly, any number of actions may be defined after any kind of events. Moreover, as illustrated in system 100 of FIG. 1, by using special script language, the user may define more complex scenarios as they need for any event set or action.

Traditional design of CCTV systems proposes environment with multiple cameras and monitor center. Monitor center provides video monitoring and control. Each camera has cable a connection with the monitoring center. There are known problem related to cabling and signal amplifiers, video loss signal and electrical noise that do not allow the design of large distributed video system.

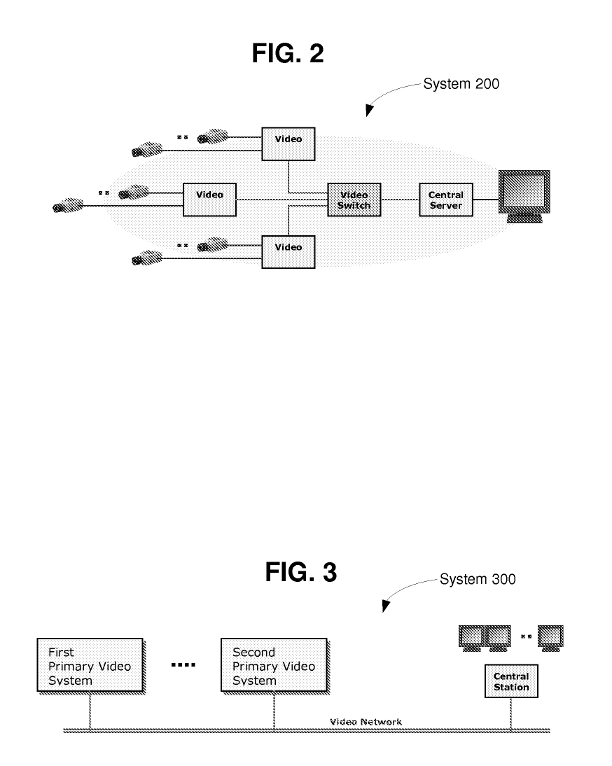

The exemplary embodiments may provide a complete digital solution in problem solving for the design of large distributed video solutions, the range of computer based networked units that collect and deliver video, audio and other data over digital communication channels. An exemplary video monitoring center may have just one network cable in order to display hundred and thousand of cameras, control pan-tilt and zoom dome devices, monitor numerous sensors and other equipment. Multiple standard video cameras may be connected to video concentrator (e.g., a “video cup”) that captures video signals, deliver compressed data into the digital video network. Any management of the video cups belongs to a cup server to provide complete remote control and video monitoring. Furthermore, multiple video cups may be connected in a “plug-and-play” network via video switch, as illustrated in system 200 of FIG. 2.

Modern networking technique grants distribution of multiple video units over a large area. Video cups connected to servers provide flexible design for large video systems. As illustrated in system 200 of FIG. 2, a primary video system may be multiplied many times as required. In addition, the distance between video cup and server is not limited. Therefore, system architecture may be simply adjusted according to the real environment.

As illustrated in system 300 of FIG. 3, the exemplary embodiments may utilize a central station as centralized monitoring, as well as a control and management system for managing numerous primary video systems. These exemplary systems may utilize software, hardware and integration tools to configure a customized security system according to specific customer needs. Event synchronized, video and audio flexible stream distributions (e.g., one-to-one, one-to-many, many-to-one, many-to-many or multiple bi-directional streams, etc.) may be achieved via a TCP/IP communication.

System control scenarios for multiple system components may include complex alarm triggering and notifications. Authorized multiple accesses to any system component may be from required location. Full-duplex system operations that do not interrupt any process to run another one (e.g., simultaneous playback and video recording). The embodiments may use intelligent video motion detection with multiple masks, delta-wavelet video compression (e.g., more then 100 times of the rate), user-defined and intuitive graphic user interface, multiple media system alerts based on rule-based engine and custom control scenarios, etc.

The exemplary embodiments may allow for the design of redundant infrastructure and distributed multi-layer architectures for rule-based management, data acquisition, analysis, storage and remote access over the video network, Internet, modem, wireless and many other connectivity media. The present invention may be the basis of the property that enables the unique flexibility, ease of integration with existing components and customization features that are available today and may be based on object oriented architecture (“OOA”), event driven systems, open ended system architecture (e.g., modular, distributed, integrated, automated, etc.), etc.

The exemplary embodiments may utilize software, hardware and integration tools to configure a customized security system according to specific customer requirements. Proposed invention will transport media, and available integrated hardware from third party manufactures. According to the systems and methods described herein, exemplary applications may include Internet service providers, xSP, Telecom.Web™ oriented advertisement, video surveillance and monitoring (e.g., restaurant, hotel/motel, etc), child-care remote monitoring, video security in mass-transit systems, “eMedicine” applications, etc. Thus, these applications may provide remote video monitoring and integration to devices, sensors and other devices. Additional applications include, assisted-living scenarios (e.g., remote monitoring for senior citizens), schools and campuses for remote monitoring, video monitoring data centers for consumer and small offices, transport vehicles and facilities (e.g., buses and stations, taxi and taxi stands, trains and stations, airplanes and airports, ships and ports, etc.), police/law enforcement, science expedition, etc. Further applications include gas/oil pipe monitoring, traffic monitoring and control, museums, art galleries, as well as other applications for video intelligent apparatus and central station, which require large number of remote cameras.

An exemplary central station may provide a new concept in object-oriented system design for enterprise complex system in multiple data monitoring, alarm messaging, control and centralize system managing analysis and reporting within integrated and distributed custom environment. The central station may combine numerous neighborhoods in unified information networks and provides centralized data access to any system component in order to manage, control and monitor the entire system.

An exemplary management process may upgrade and configure system architecture to perform such task as file management, remote system operation, configuration of any system location, as well as providing definition of control scenarios, macros, time schedules, user rights, etc. An exemplary control process may provide complex remote control of system environment at any location including control of pan-tilt and zoom dome cameras, alarm receivers, relays, audio notification equipment, video recording, motion detectors, archives, printers and other system components. An exemplary monitoring process may include all processes related to view and play video, audio, monitor event and alert messages, retrieve archives, export video and still images, etc.

Multiple central stations may be distributed over large area may build intelligent video network, where any system node shares all system recourses and provides redundant system architecture for event databases, messaging and environment monitoring. The network may include multiple user rights, wherein each Central Station may handle predefined task assigned to specific system area. In addition, the central station may require data acquisition systems in the video network for management, control and monitoring. Accordingly, a system with user-defined functionality that is controlled by the central station may be simply adjusted to specific requirements of wide range complex and integrated into “Enterprise Solutions” for various of applications. As noted above, these various applications may include Smart City, Olympic village, border control, highway and pipe line, incorporation, banking and hotel suites, central stations, housing authorities, solutions for corporate facilities, data center, central stations, environment monitoring, incorporation video, video/data framework, city agency as monitoring and management, center for correspondent facilities, head office, ISP, ASP, retail chains, hotel chains, airport, sport center, prisons, housing authorities, facilities network, train station, subway, bus stations, power stations, customs, immigration centers, law enforcement agencies, traffic monitoring, plant and industrial surveillance, as well as many other applications.

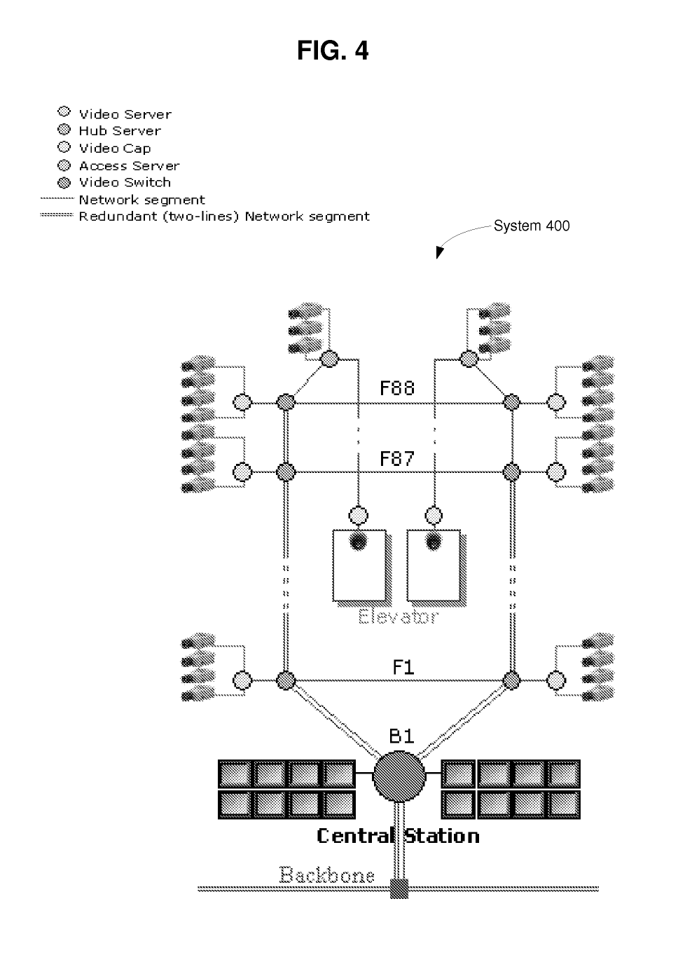

As illustrated in system 400 of FIG. 4, the central station may include all system processes related to view and play video, audio, monitor event and alert messages, retrieve archives, export video and still images, etc. Multiple distributed system processes enhance fault-endurance, provides relative intelligence at each location and simplifies system control in complex environment. The exemplary central stations may be networked and managed systems that enable complete remote monitoring and control of the entire system environment. Components of this system environment may include, video intelligent apparatus, video archives, video routers, ATM intelligent apparatus, face capture, body tracking, remote stations and other systems over TCP/IP networks. These central stations may be simply multiplied in the network or Internet in order to provide complex custom design for monitoring and control for multi-layer accesses to system environment.

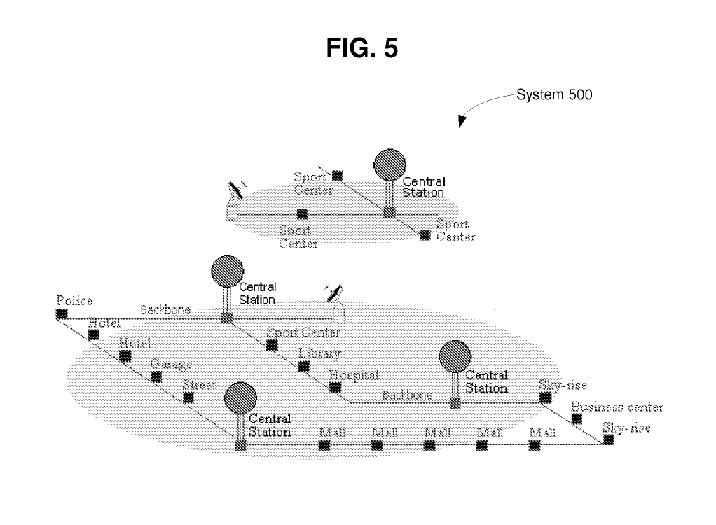

System 500 of FIG. 5 illustrates a sample architecture of distributed solution over large area, such as for a “Safe City” (or E-City), Olympic village, border, highway and pipe line corporations, banking and hotel suites, central stations, housing authorities and more. The video intelligent apparatus designed as high performance data acquisition and rule-based video recording system. It may provide integrated video, audio and event acquisition, synchronous agglomeration, simultaneous monitoring, control, rule-based alarm messaging and data distribution into a “plug-and-play” video Network. This system may be used for remote managing and monitoring of multiple video inputs through the video network, Internet or modem connection. This system may combine all the features of intelligent video firmware and offers the greatest flexibility in system control data monitoring and data acquisition. For example, basic concepts of an exemplary video intelligent apparatus may be include rule-based video recording and surveillance, user-defined rules to control video recording and video screens will provide flexibility for your organization and your system operators.

For integrated video security, the video intelligent apparatus provides isolated or synchronous audio/video recording and playback. A microphone may be used as an audio sensor that detects alarms and trigger other system processes. The integrated video intelligent apparatus may provide full-range customization in the design of “Enterprise Solutions” for video security for access control, ATM, POS and other applications. For automation, the video intelligent apparatus provides flexibility in environments such as system automation and control. Features of the exemplary video intelligent apparatus may include, but are not limited to, a powerful video processor for each camera, built-in VMD, video loss detector, delta-wavelet based video compressor, channel prioritization, brightness, color and other controls that may follow a maxim of full-triplex system operation.

For remote system access from any location, the secure remote control, monitoring and event annunciation at any required system location. Accordingly, any function that offered by the video intelligent apparatus may be accessed from the remote site. For secure system access, multiple user rights agreements and groups will provide powerful security for access control with the system for monitoring, control and management. The exemplary systems may provide secured administrative rights on the video intelligent apparatus locally and at any other site remotely. A flexible GUI and intuitive system operations of the exemplary system offers the user a unique opportunity to customize graphic user interface and manage it on the fly. For instance, “one-click” system operation and clear hierarchy of visual components provides simple operation and multi-purposed system monitoring and control may eliminate any long term training required to understand for qualified operators.

The video intelligent apparatus may be the basis for a “universal engine” integrating the best features of modern technology in a customize design, for any sized applications. Multiple video intelligent apparatus in the “intelligent video network” offers redundant “enterprise class video security solution.” The exemplary video intelligent apparatus may provide an option to choose the type of the network connection. For example, Ethernet connections may be supported, as well as ISDN, dial-up connections, etc., in order to also accommodate regions where access to digital networks is limited.

As noted above, applications may include banks (e.g., multi-branches and headquarter), border patrol, military zones, power & nuclear plants, traffic monitoring, environment and pollution control, safe city of the future, police station, toll stations, national parks, recreational facilities, water reservoir, national recourses, video global positioning, data center, airport facilities, fire department, power station, sea port, train station, bus station, smart building and sky-scrapers, smart factory, processing plant (e.g., a fully integrated plant), postal office, sport center and complexes, smart mall, supermarket, retail store, parking lots, building garages, apartments, digital home, offices, hotels, motels, eEducation, eMedicine, hospitals, ambulance, health's care and senior help, university, library, school, kindergarten, nanny/child care remote monitoring, museums, art galleries, restaurants, smart prisons, industrial buildings, drug & poisonous material control, and much more only limited to the integrators imagination.

Multiple virtual screens with hierarchy of: digital multi-layer map, event viewer, multipurpose video monitor, teleconference or audio play station, user control dialogs. Flexible split screen video monitor and camera order, sequential camera view. Event-based voice, E-Mail, dial-up, popup and relay-output event messaging. Multiple built-in integrated I/O controls. Regional assignments for each system component: Operators will always get sufficient information for quick analysis and the ability to make fast decision during or after any event or alert across the system, because the system provides custom-definition of regional assignment for any system component.

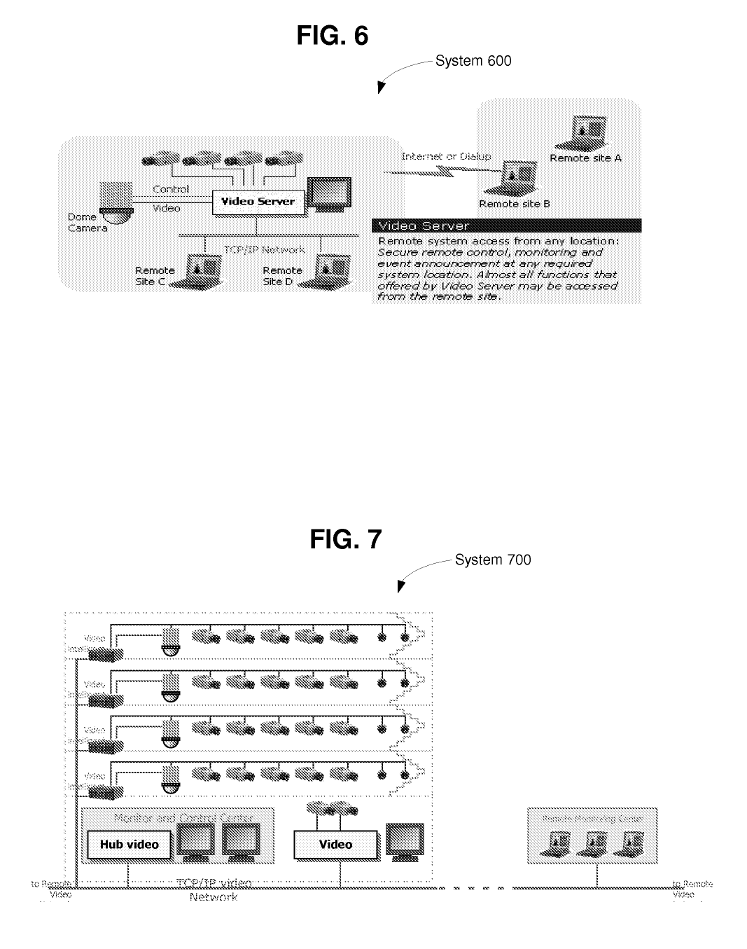

System 600 of FIG. 6 illustrates an exemplary system architecture, wherein stand alone video intelligent apparatus coordinates with numerous remote stations.

A hub video intelligent apparatus is middle-ware system based on the video intelligent apparatus and designed for management, control and monitoring of numerous Video intelligent apparatus hubs over the video networks. Compared with the video intelligent apparatus, the hub video intelligent apparatus does not support local cameras. The hub video intelligent apparatus provides access to networked Video intelligent apparatus hub in order to gather data, control its environment and manage it.

Advantages of the hub video intelligent apparatus based solutions may relate to simultaneous monitoring and control of numerous remote video intelligent apparatus hub based sites over the video Network. For instance, a single wired connection may be utilized for numerous cameras and security equipment. The hub video intelligent apparatus system is universal engine for custom-designed applications. It is programmable and provides wide range of functionalities, such as for remote control and video monitoring, rule-based digital video recording, alarm notification and messaging.

A stand-alone hub video intelligent apparatus can monitor large networked integrated environments. Complex application may be based on multiple hub video intelligent apparatus within video networks and follows the rules of a distributed system. Hub video intelligent apparatus based solutions may be oriented for large distributed video surveillance and video security. Stand-alone or multiple networked Video intelligent apparatus may be as basis part at local control and monitoring center in Safe city, district, smart building, garage building, sky-rise, university, library, supermarket, hotel, smart prison, pipe line oil-gas, highway, sea port, airport, train and train station, museum, gallery, restaurant, power station, recreation area, sport center, ISP, ASP, border and military objects, plant, factory, etc.

Delta-wavelet video compression and rule-based digital video recording provides local video archiving for any duration of time (e.g., weeks and months). All video and data are delivered from Video intelligent apparatus hub sites. System 700 of FIG. 7 illustrates a sample system architecture including multiple video intelligent apparatus hubs under centralized supervision of several hub video intelligent apparatus.

The mobile apparatus is a mobile Digital Video Recording system that is designed for compact mobile video solutions, which require power-safe, shock-proof, low-maintenance, with easy-to-use operations for data allocation in video surveillance, video security and digital video recording applications. Mobile apparatus is proposed for video/audio acquisition, storage, monitoring and data acquisition and delivery with automated features. Mobile apparatus collects multiple compressed videos on internal storage, mobile. Further more delivery of stored data to video central stations to archive or manage in a site consist manner with two options. Mobile apparatus can operate in a complete autonomous mode. Video monitor and input/outputs (“I/O”) are standard. The mobile apparatus may be programmed at mDock site or over the video network and/or on-line from the central station or another stationary management site.

Mobile apparatus is designed for mobile connectivity for monitoring and control, and can be archived for management of, for example, video and Audio Acquisition, event-Based Digital Video Recording, rule-based Alarm Messaging, control and Monitoring.

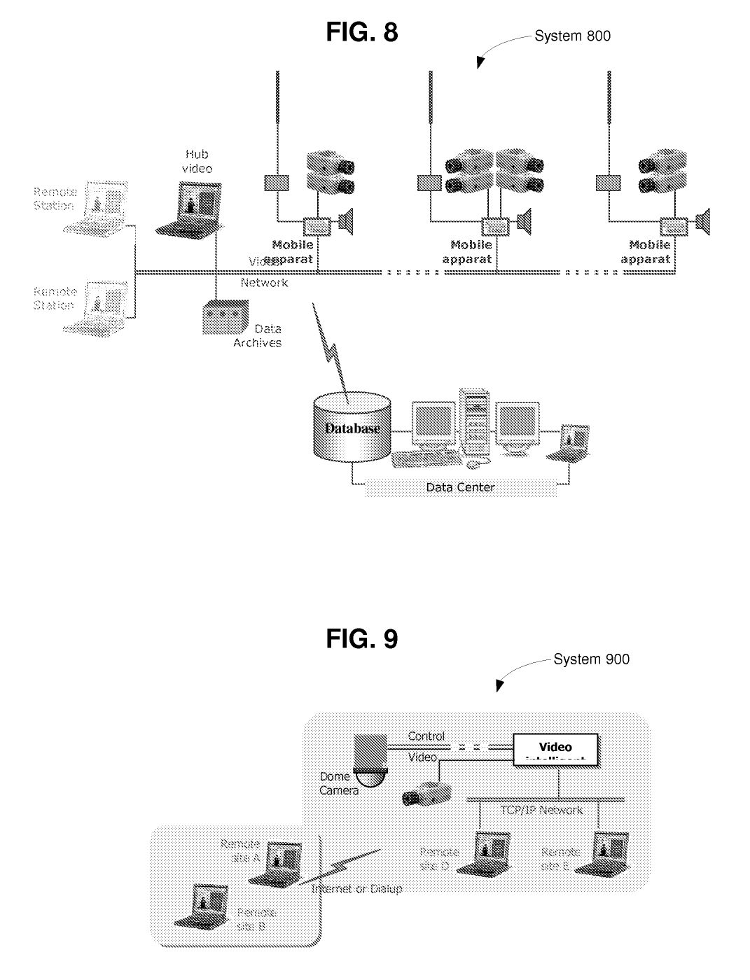

System 800 of FIG. 8 illustrates a sample system architecture including multiple networked mobile apparatus.

Stored data at mobile site may be simply uploaded to stationary archive server via wireless, wire network or removal of the mobile module. The video intelligent apparatus hub may provide a compact solution for remote video acquisition for compressing and delivering data into the IP video network. Furthermore, the hub may be utilized for video/event transmission and monitoring provided, at the server site over the video network or modem.

The video intelligent apparatus hub is designed for compact indoor or outdoors solutions that require video surveillance or/and video security for remotely located cameras from one or more monitoring sites. A single communication line between video intelligent apparatus hubs and server site simply collects all data from multiple cameras, alarm inputs and can pan-tilt and zoom cameras as well as alarm custom equipment. The Video intelligent apparatus hub may be designed using embedded technology and non-mechanical technology. For instance, the hub may not require video monitor, keyboard, joystick or mouse, etc. All controls and managing may be provided from a server site. In addition, the video intelligent apparatus hub has built-in video motion detector and video loss detector.

Modem auto-pickup feature provides video on demand at remote sites. Modem auto-dialup feature provides backup connection when the Network connection is lost or broken. Instantly, initialized from the Server site, the Video intelligent apparatus hub provides sensor analysis, pan-tilt & zoom of dome camera and relay control according to system scenario or manual operation. Multiple video cameras may be monitored and controlled simultaneously via single Ethernet cable or modem connection.

The exemplary embodiments may allow for multiple video streams over single communication channel. For instance, the video intelligent apparatus hub may collect multiple video streams and deliver it in single communication channel, Ethernet network or dialup. The video intelligent apparatus hub may provide a solution for multiple remote video monitoring/control with minimum low cost cables. If it is required, dialup connection may support auto dial-out and dial-in.

The monitoring systems may feature pan-tilt and zoom dome camera support, wherein a single communication media is sufficient solution for control of multiple pan-tilt and zoom dome cameras from remote site, video intelligent apparatus, remote station, etc. The monitoring systems may a built-in video loss detector, wherein the digital system may provide instant notifications instantly any evidence losses of the video signal, camera disconnected, loss power or malfunction. The VMD functionality allows for motion detection for each camera within the video security. Accordingly, since the video motion detector may be intelligent and based on adopted innovative bionic methods, the system may scalable to include any user-defined applications and specifications. The applications may include outdoor video motion detection, multiple motion masks with flexible shape, sensitivity adjustments for the size and contrast of active object, visual outlining of active object in the scene, filtration of optical noise, video loss detection, wavelet video compression (e.g., primary of up to 50 times; secondary of up to 4 times, for a total of up to 200 times), embedded event-driven engine with the client for remote connectivity, monitoring and control, watch-dog applications, quick restart unit when malfunction detected, etc. Various network interfaces of the system may include serial, RS485, 10 Mbps Ethernet, dial-up, 56 k modem (e.g., auto-pickup, and dialup), alarm resistance inputs, alarm relay outputs, etc. Storage functionality may include flash-based storage, alarm-based record, non-stop loop based record, no mechanical parts, etc.

As described above, the video intelligent apparatus hub supports numerous remote clients for video monitoring and camera control. Accordingly, multiple remote sites may access any video intelligent apparatus hub for simultaneous video monitoring or/and camera control. Any system access may be based on customized user rights in order to prevent collisions in the system control.

The video intelligent apparatus hub supports digital connectivity for instant delivering video, audio and alarm data to the server site, which can collect and store, monitor (e.g., video, audio, alarm input, etc.), control (e.g., pan-tilt & Zoom, alarm output) and analyze (e.g., VMD) system environment at the Video intelligent apparatus hub site.

System 900 of FIG. 9 illustrates an exemplary audio input system architecture including a stand-alone video intelligent apparatus hub with numerous remote stations over different kind of media.

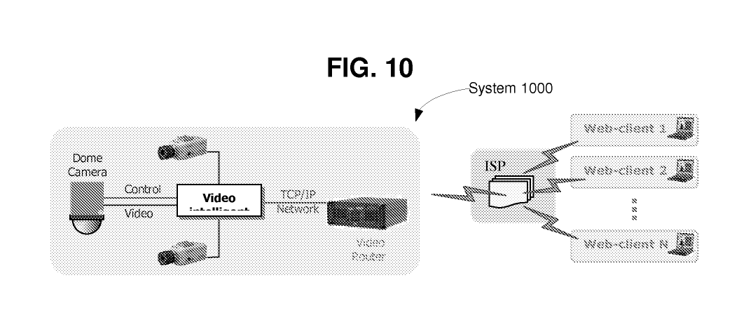

System 1000 of FIG. 10 illustrates sample architecture for video intelligent apparatus hub as the basis component for multicast video over the Internet. Exemplary applications for such video surveillance may include schools, day care center, library, supermarket, restaurant, video report of sport, outdoor and other activities, video advertisement and product promotion, etc.

An exemplary video router mat provide “video data distribution” between multiple Internet clients and video segments of the intelligent video network. For instance, the video router may provide Web-video multicasting to multiple Internet clients with secure access from the Internet via a built-in firewall. The video router may be a basic part for the Internet connection for two or more video systems. Accordingly, the video router may provide solutions for, but not limited to, video surveillance over the Internet, Internet service provider (“ISP”), ASP, Internet advertisement and promotion, monitoring of public activities and events, video security & teleconferencing, data centers, museum, art gallery, view point, shopping-mall, supermarket, restaurant, sport center, recreation area, etc.

An exemplary ATM intelligent apparatus is a specialized product designed for remote security, video monitoring, digital video recording, and automated alarm notification of ATM banking machines. The ATM intelligent apparatus may be integrated with all of the product line to provide flexible custom defined solution over the network. For instance, “intelligent video networks” provide integrated solution for “event driven” credit card processing and digital video recording. Exemplary applications may include Banking system and cash dispenser network, ATM, etc.

An exemplary POS intelligent apparatus may be designed for video monitoring, digital video recording and synchronous operation with the integrated point of sale terminal and other equipment including, turnstiles, bar code readers or scanners, etc. The POS intelligent apparatus system provides total control for any POS operation including an integrated reporting tool of all POS operations, as well as a video database, which is fully synchronized with all corresponding POS operations. The exemplary applications for integrated video security POS operations may include video surveillance, remote control and monitoring, rule-based digital video recording. The POS intelligent apparatus has a simple mechanism for data search, based upon an event. For example, a report can be generated when the cash-box has been opened, or when a sale has occurred without the use of a bar-code scanner, etc. In other words, the system can be designed to react to any pre-determined event. The POS intelligent apparatus system is based upon technology, which allows for the customization of a completely integrated, scalable and distributed system. A complex and powerful system to help prevent theft can be developed through the simple integration with other equipment. Integrated equipment functions within a single information network and has centralized or distributive remote monitoring and control capabilities.

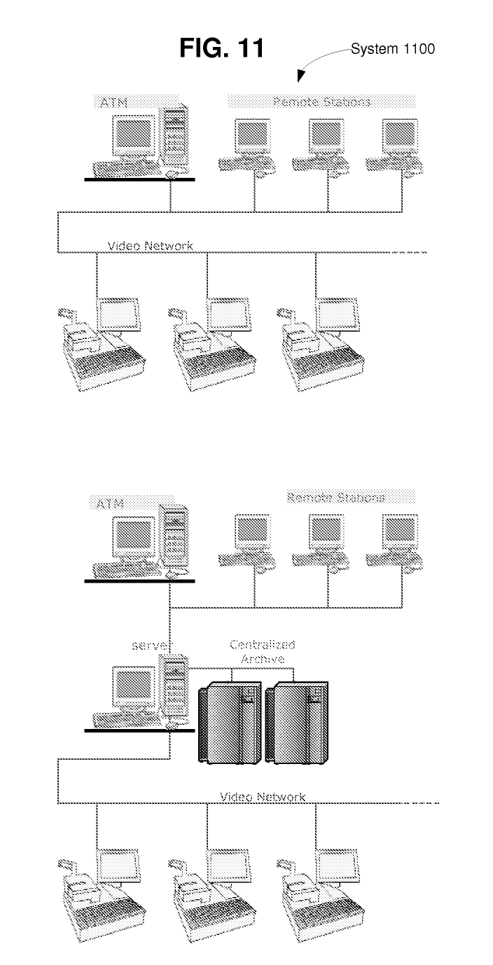

The scalability may be achieved by modular system architecture that allows for the addition of new system components (e.g., additional POS devices, turnstiles, bar code readers, scanners, etc.). The exemplary distributed POS intelligent apparatus systems may support numerous remote stations over TCP/IP Networks for remote monitoring and control. Data encryption and fault alerts are adjustable according to specific scenarios and customer requirements. System 1100 of FIG. 11 illustrates an exemplary system architecture for the POS intelligent apparatus.

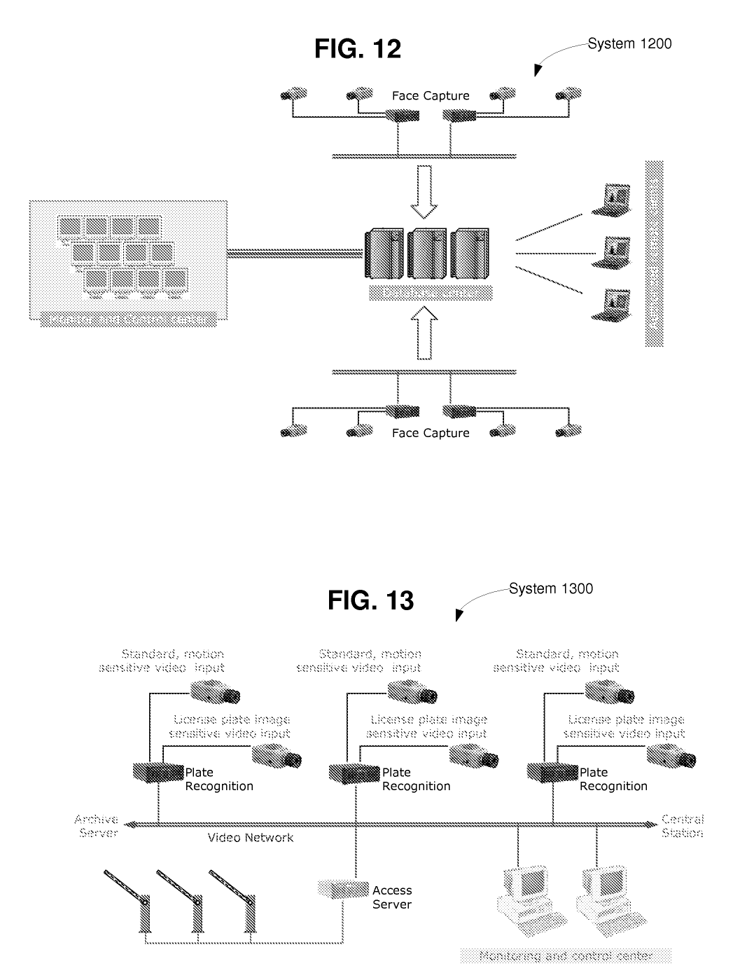

System 1200 of FIG. 12 illustrates an exemplary face capture function designed for detection and capturing of human faces. Accordingly, face-capturing features may be integrated into the video intelligent apparatus that provides time-synchronization of video and event data. Face capturing allows ease of search thru “thumb nail video clips” in the archive by query of human face image or event. Captured faces may be stored, forwarded to other sites via e-mailed, print or burned to CD-RW, DVD or DDS-4 (DAT) according to system requirement and control scenario. The system control scenarios can provides the establishment of complex relations between multiple systems and events in order to generate required reaction. The Face Capture system does not require special cameras and may be adjusted to normal Indoor and Outdoor environments. Using the face-capturing function, a face capturing component may handle additional tasks in various applications and enhance the defense-level of secured environments. As noted above, applications may include government facilities, military facilities, port authorities, nuclear power plants, boarder crossings, etc.

System 1300 of FIG. 13 illustrates a LPR designed a proprietary software module for license plate recognition. Accordingly, LPR may be implemented in Video intelligent apparatus system and provides utilization of real time method for car license plates detection, capturing, recognition and analysis. The LPR system is designed for automatic detection of multiple car plates in real camera scenes.

The captured and recognized license plate will be recorded in to a database and forwarded to analysis engine that may compare it with queried numbers. User-defined reaction and comparison for positive or negative result can trigger required process within the video network. The database of the LPR system provides synchronization of all data, images, video and events. The complexity of the integrated system environment may be adjusted according to various system requirements in the range of operation with numerous sensors like video motion detection, audio, human body detection, fingerprint readers, access control, and other alarm sensors. Therefore, the LPR system may provide a solution for applications within integrated video security tracking license plates within large and distributed monitored areas. Furthermore, the LPR is not limited to simply to view license place, and may also provide information related to traffic and real flux of cars on highway.

Sample solutions may include stand-alone, multiple distributed or integrated license plate recognition systems solving numerous tasks related to License Plate identification at locations such as, but not limited to government facilities, military facilities, boarder crossings & customs check points, bridges & tunnels, hazardous material sites, highways, etc. Alternative applications may include parking lots and garages buildings, smart building, toll station, traffic monitoring and control, access control system, digital home, office, etc.

An exemplary archive server is designed for high-end “enterprise class networked video security solutions” that require long-term data archiving for months and years. The archive server may work in the video network and provides two options for video/audio data archiving (e.g., tape library or disk array). Multiple sites may have secured access to archive server in order to store video and audio, and retrieve data remotely. Data archive systems may be designed for centralized data collection from numerous sites over the video network. The archive server may be located at the same site where others systems exist (e.g., in proximity to the central station, video intelligent apparatus, remote station or disaster recovery sites located within the system architecture). Alternatively, the archive server may be located remotely, in secure and protected environment in order to prevent evidence tampering, damage, data loss, theft and non-authorized accesses. Furthermore, the remote connection may be redundant.

At numerous “living” sites: remote, local or mixed. The system architecture with multiple networked Archive Servers defines redundant solution for “enterprise class” applications. Large video/audio data archives may offer two solutions for long time data archiving (e.g., terabyte servers, DVD disk arrays, tape library, etc.). A user's method may depend on the criteria of organizations operation as well as the number of multiple direct accesses or sequential access, high and low cost solution, and any number of other factors.

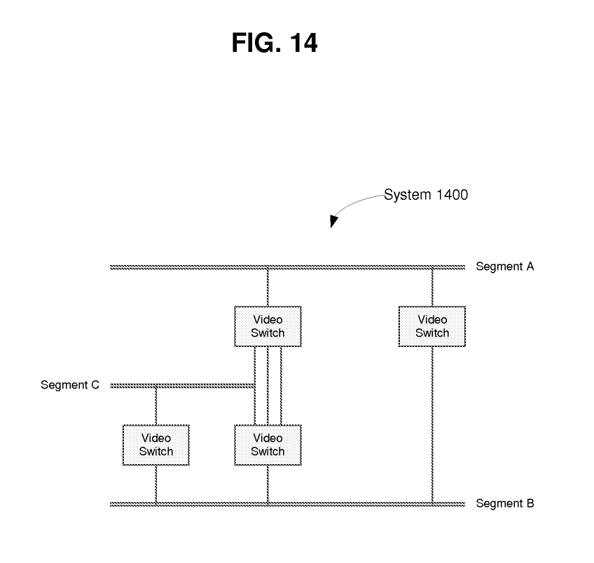

As illustrated in system 1400 of FIG. 14, every segment may contain numerous video systems that define customized architecture. For synchronized data archives, system events and video/audio data are stored in the archive in time synchronous manner. For disk array solution, the archive server grants local and remote users authorized access for synchronized video and audio playback, search, and data export. Multiple accesses may be secured via password, access control and time schedule. For data update, every site provides operational video archiving locally and may update archive server manually or repeatedly, according to time schedule or other custom-defined event. Offers solutions that may be simply adjusted to high-end custom requirements in order to support reliable data archiving to “multiple living sites.” For remote and secured environment, the archive server may be located in your secure and clean environment in order to maintain evidences and mitigate damage, data loss and non-authorized access. For redundant architecture, multiple archive servers across the video network defines you redundant solution for “enterprise class applications.” For system alert and notification, archive servers will notify the system administrator instantly about access into the system, full archive, ejected tape, and disconnection; system busy and other unexpected event via custom defined notification media.

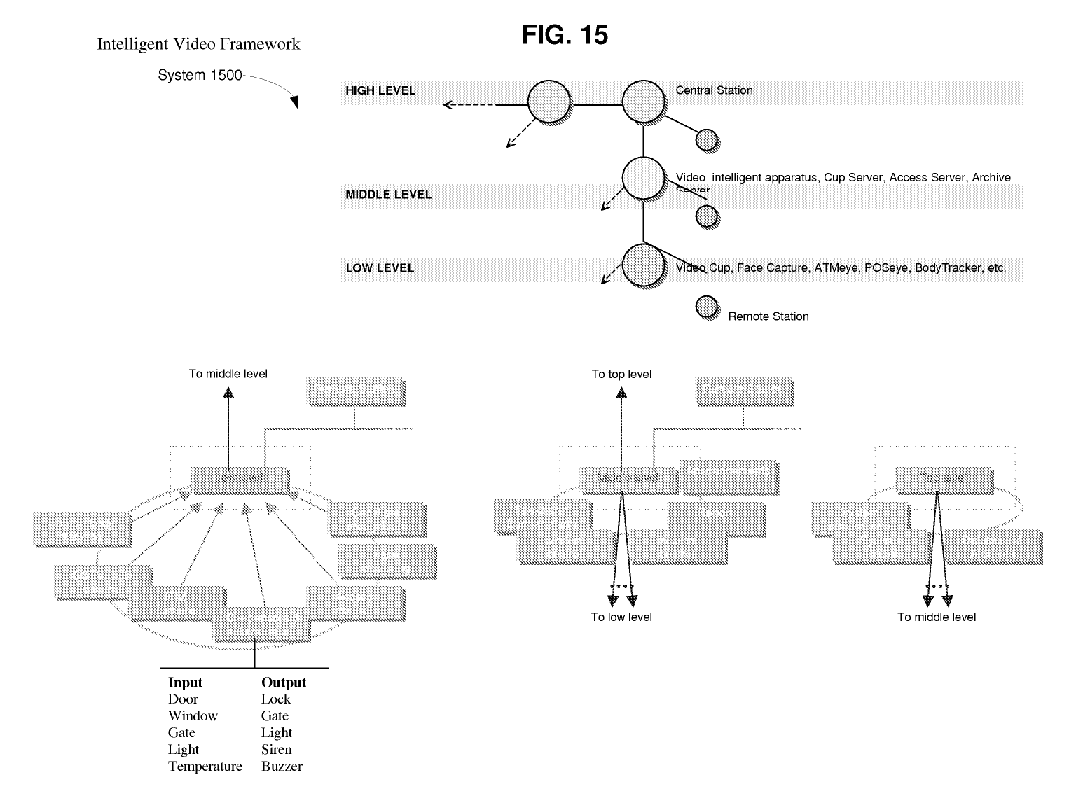

System 1500 of FIG. 15 illustrates an exemplary intelligent video framework, including high level, mid level, and lower level arrangements.

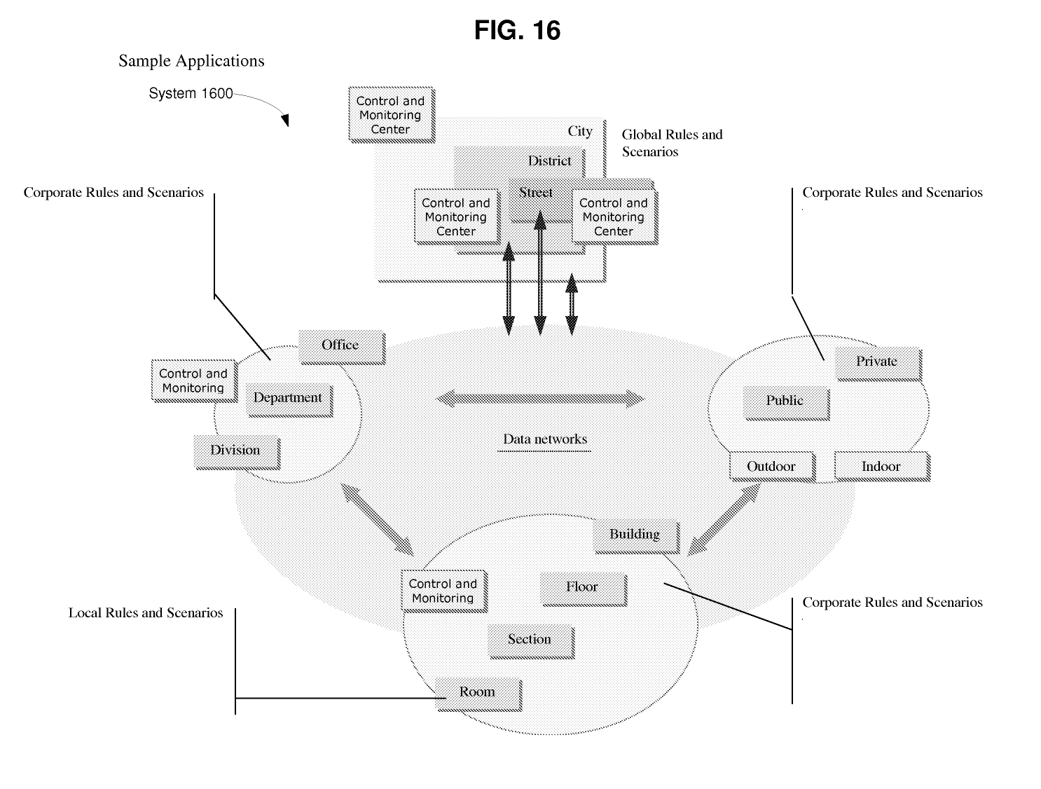

System 1600 of FIG. 16 illustrates sample applications acquiring surveillance data within a populated environment with an intelligent monitoring arrangement, and for monitoring, managing, and analyzing the surveillance data within the populated environment.

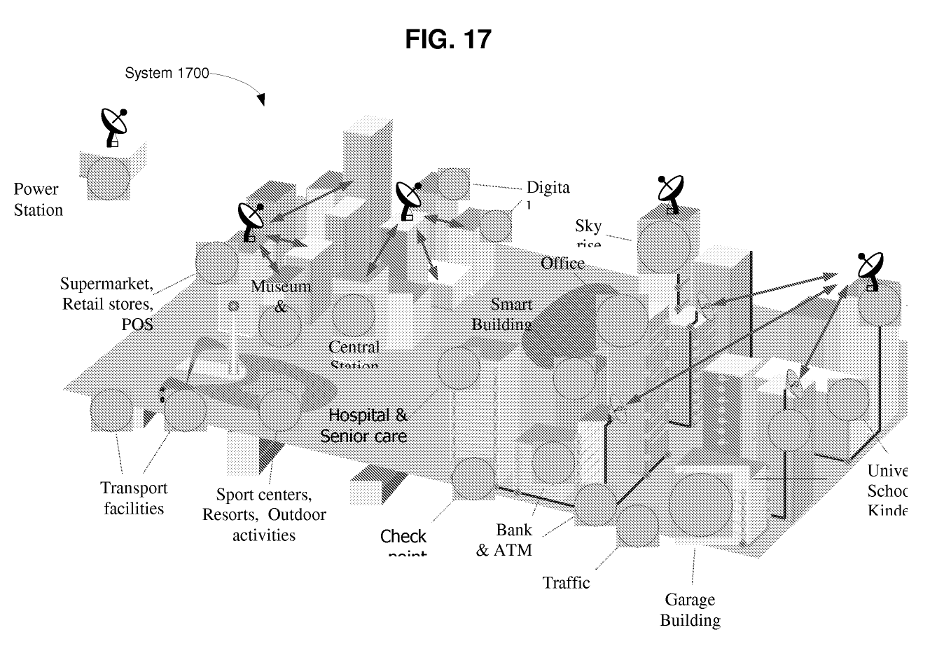

System 1700 of FIG. 17 illustrates an exemplary intelligent video framework for an integrated, distributed, multi-layer intelligent video framework for automation, video monitoring, annunciation, digital video recording, CCTV security, access control, fire alarm, tracking, as well as for others purposes.

According to the exemplary embodiments described herein, applications for the systems and method may include, but are not limited to location such as digital video/audio data center, city agencies as monitoring and management center for correspondent facilities of the city, incorporation video framework, water reservoir, national recourses, video global positioning, data centers, aircraft yellow/black box, airport facilities and management center, police stations, fire departments, power stations, alarm centers, banking systems and cash dispenser network, ATMs, bank and business corporations, access control systems, seaports, train stations, bus stations, and transportation management centers, smart buildings, smart factories/plants (e.g., full integrated), postal offices, traffics monitoring and control centers, etc.

Exemplary embodiments described herein may also be applied towards mobile integrated video security WAN, sport arenas, centers and complexes, Olympic facilities, personnel access bureaus, car tracking/counting, and live identification, transport facilities (train, bus, taxi, ship, etc.), vandalism triggering systems, police car, emergency vehicles, science expeditions, human face image pattern analysis and database support, human body detection and tracking, fast pan-tilt control, tracking object, auto-tracking and search over large area, shopping centers, malls, supermarkets, retail stores, POS, turnstiles, toll stations, checkpoints, border access control, parking, parking lots, garage building, garage buildings and parking lots, residential areas, apartment complex, gated communities, condominium centers, digital homes/offices, yards, motel, etc.

Exemplary embodiments described herein may also be applied towards applications used for e-medicine, hospitals, health care centers and senior help centers, campuses, universities, education locations, libraries, school, kindergarten, child and guardian/nanny remote monitoring, museums, art galleries, expositions, utility pipe line, oil and gas locations, restaurants, casinos, night clubs and commercial management centers, prisons, industrial buildings, drag & poise material control, hotels, motel and housing management networks, remote business, industrial monitoring, automated processes, intelligent video robot, Internet service providers, XSP, telecom, web oriented advertisement, web enabled video surveillance and monitoring, outdoor activities and event centers, remote video applications, satellite communications (e.g., Iridium, GlobalStar, etc.), etc

It is claimed:

1. A method, comprising:
acquiring surveillance data of a predetermined geographical area using a monitoring arrangement;
analyzing the surveillance data to detect at least one of a predetermined activity and a predetermined behavior of a entity within the predetermined geographical area; and
adjusting at least one operation within the predetermined geographical area based on the at least one predetermined activity and predetermined behavior of the entity.

2. The method of claim 1, wherein the acquiring, analyzing and adjusting steps are performed by a central station server.

3. The method of claim 1, further comprising:
storing the acquired surveillance data in a storage and archive retrieval system; and
providing access control for data collection, data management, and data search functions.

4. The method of claim 1, further comprising:
authenticating the entity within the environment, wherein input for the authenticating is received by one of a camera, a microphone, a sensor, a relay, a speaker, a card reader, an ATM machine, and an RFID reader.

5. The method of claim 1, further comprising:
notifying a surveillance administrator according to a rule-based notification policy, wherein the notification includes at least one of a visual and a audible alert.

6. The method of claim 1, wherein the monitoring arrangement includes at least one of a data hub, at least one data monitor, and a data network.

7. The method of claim 1, wherein the network includes at least one data router and at least one data switch.

8. The method of claim 1, wherein the monitoring arrangement includes at least one of a face capturing arrangement, an object/body tracking arrangement, and a license place recognition arrangement.

9. The method of claim 1, wherein the monitoring arrangement includes at least one of a traffic monitoring camera, an access control camera, an ATM camera, a POS camera, a motion sensor, and an access control sensor.

10. The method of claim 1, further comprising:
managing controls of the monitoring arrangement via one of a remote station operator and a remote station administrator.

11. The method of claim 1, wherein the predetermined geographical area is one of a city, a town, a campus, a university, street location, public parking location, park and recreation area, private business location, government location, residential location, apartment building complex, garage and outdoor environment, police station location, hospital location, garage location, public storage location, public transportation location, and port location.

12. The method of claim 1, wherein the entity is one of a person, a vehicle, a package, an access point, and an item of interest.

13. A system, comprising:
a computing arrangement acquiring surveillance data within a predetermined geographical area; and
a server analyzing the surveillance data to detect at least one of a predetermined activity and a predetermined behavior of a entity within the predetermined geographical area, and adjusting at least one operation within the predetermined geographical area based on the at least one predetermined activity and predetermined behavior of the entity.

14. The system of claim 13, further comprising:
a storage and archive retrieval arrangement storing the acquired surveillance data; and
an archive interface arrangement providing access control to the server for data collection, data management, and data search functions.

15. The system of claim 13, further comprising:
an authentication arrangement authenticating the entity within the predetermined geographical area, wherein the authentication arrangement includes at least one of a camera, a microphone, a sensor, a relay, a speaker, a card reader, an ATM machine, and an RFID reader.

16. The system of claim 13, further comprising:
a notification arrangement notifying a surveillance administrator according to a rule-based notification policy, wherein the notification includes at least one of a visual and a audible alert.

17. The system of claim 13, wherein the computing arrangement includes at least one of a face capturing arrangement, an object/body tracking arrangement, a license place recognition arrangement, a traffic monitoring camera, and an access control camera.

18. A non-transient computer readable storage medium including a set of instructions that are executable by a processor, the set of instructions being operable to:
acquiring surveillance data of a predetermined geographical area using a computing arrangement;
analyzing the surveillance data to detect at least one of a predetermined activity and a predetermined behavior of a entity within the predetermined geographical area; and
adjusting at least one operation within the predetermined geographical area based on the at least one predetermined activity and predetermined behavior of the entity.

19. The non-transient computer readable storage medium of claim 18, wherein the set of instructions are further operable to:
store the acquired surveillance data in a storage and archive retrieval system; and
provide access control for data collection, data management, and data search functions.

20. The non-transient computer readable storage medium of claim 18, wherein the set of instructions are further operable to:
authenticate the entity within the predetermined geographical area, wherein input for the authenticating is received by one of a camera, a microphone, a sensor, a relay, a speaker, a card reader, an ATM machine, and an RFID reader; and
notify a surveillance administrator according to a rule-based notification policy, wherein the notification includes at least one of a visual and a audible alert.
